(19) United States
(12) Patent Application Publication
(10) Pub. No.: US 2026/0358840 A1
(43) Pub. Date: Nov. 12, 2026

(54) Pressure Control Device and Apparatus Control System

(71) Applicant: KOGANEI CORPORATION, Tokyo (JP)

(72) Inventors: Toshio FUKASAWA, Tokyo (JP); Yoshihiro TAKAHASHI, Tokyo (JP); Yuichi HIRAMOTO, Tokyo (JP)

(73) Assignee: KOGANEI CORPORATION, Tokyo (JP)

(21) Appl. No.: 19/649,059

(22) Filed: Apr. 15, 2026

Related U.S. Application Data
(63) Continuation of application No. PCT/JP2024/030307, filed on Aug. 26, 2024.

(30) Foreign Application Priority Data
Oct. 26, 2023 (JP) 2023-183807

(51) Int. Cl. G05D 16/20

(52) U.S. Cl. CPC G05D 16/2026

(57) ABSTRACT

A pressure control device includes a gas supply valve connected to an input flow path and a gas exhaust valve connected to the gas supply valve via a connection flow path. The pressure control device includes a control board part including a memory storing a feedback control program and controlling the gas supply valve and the gas exhaust valve. The pressure control device includes a first communication port connected to the control board part via a first communication line and receiving target pressure data used for the feedback control program. The pressure control device includes a second communication port connected to the control board part via a second communication line and receiving rewrite data of a user setting value included in the feedback control program.

### CROSS-REFERENCE TO RELATED APPLICATIONS

This is a continuing application, under 35 U.S.C. § 120, of copending international application No. PCT/JP 2024/030307 filed on Aug. 26, 2024, which designated the United States and was not published in English; this application also claims the priority, under 35 U.S.C. § 119, of Japan Patent Application No. 2023-183807 filed on Oct. 26, 2023; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present disclosure relates to a pressure control device and an apparatus control system.

### BACKGROUND OF THE INVENTION

In order to control a pressure of a fluid supplied to a control-target apparatus such as a wafer polisher, Japanese Patent Application Laid-Open Publication No. 2022-37588, proposes a pressure control device called an electropneumatic regulator. When the pressure of the fluid is controlled by using such a pressure control device, the control-target apparatus such as the wafer polisher can be controlled.

Thus, a need exists to overcome the problems with the prior art systems, designs, and processes as discussed above.

### SUMMARY OF THE INVENTION

The systems, apparatuses, and methods described provide a pressure control device and an apparatus control system that overcome the hereinafore-mentioned disadvantages of the heretofore-known devices and methods of this general type.

Incidentally, in order to appropriately control the control-target apparatus, it is necessary to quickly converge the pressure of the fluid supplied to the control-target apparatus toward a target pressure. In addition, in order to quickly converge the pressure of the fluid toward the target pressure, it is important to adjust a feedback control program in accordance with a configuration of equipment in which the pressure control device is embedded. Accordingly, the feedback control program includes a user setting value such as a proportional gain, and it is important to appropriately adjust the user setting value in accordance with the configuration of the equipment. However, it has been difficult to embed a mechanism for adjusting the user setting value into the pressure control device that needs to be downsized. Accordingly, it has been required to allow the adjustment of the user setting value while avoiding an increase in the size of the pressure control device.

According to the present disclosure, a pressure control device includes a main body part including an input flow path communicating with an input port, an output flow path communicating with an output port, and a gas exhaust flow path communicating with a gas exhaust port. The pressure control device includes a gas supply valve attached to the main body part and connected to the input flow path. The pressure control device includes a gas exhaust valve attached to the main body part and connected to the gas supply valve via a connection flow path. The pressure control device includes a control board part including a memory for storing a feedback control program and controlling the gas supply valve and the gas exhaust valve. The pressure control device includes a first communication port connected to the control board part via a first communication line and receiving target pressure data used for the feedback control program. The pressure control device includes a second communication port connected to the control board part via a second communication line and receiving rewrite data of a user setting value included in the feedback control program.

According to the present disclosure, an apparatus control system includes a pressure control device controlling a pressure of a fluid flowing from an input port to an output port, based on a feedback control program. The apparatus control system includes a control-target apparatus connected to the output port via a fluid piping. The apparatus control system includes a first control apparatus communicably connected to the pressure control device and transmitting target pressure data used for the feedback control program. The apparatus control system includes a second control apparatus communicably connected to the pressure control device and transmitting rewrite data of a user setting value included in the feedback control program. The pressure control device includes a main body part including an input flow path communicating with the input port, an output flow path communicating with the output port, and a gas exhaust flow path communicating with a gas exhaust port. The pressure control device includes a gas supply valve attached to the main body part and connected to the input flow path. The pressure control device includes a gas exhaust valve attached to the main body part and connected to the gas supply valve via a connection flow path. The pressure control device includes a control board part including a memory for storing the feedback control program and controlling the gas supply valve and the gas exhaust valve. The pressure control device includes a first communication port connected to the control board part via a first communication line and communicably connected to the first control apparatus. The pressure control device includes a second communication port connected to the control board part via a second communication line and communicably connected to the second control apparatus.

According to the present disclosure, the pressure control device includes the first communication port and the second communication port. In this manner, a user setting value can be adjusted while an increase in a size of the pressure control device can be avoided.

With the foregoing and other objects in view, there is provided, a pressure control device controlling a pressure of a fluid flowing from an input port to an output port comprising a main body part including an input flow path communicating with the input port, an output flow path communicating with the output port, and a gas exhaust flow path communicating with a gas exhaust port, a gas supply valve attached to the main body part and connected to the input flow path, a gas exhaust valve attached to the main body part and connected to the gas supply valve via a connection flow path, a control board part including a memory storing a feedback control program and controlling the gas supply valve and the gas exhaust valve, a first communication port connected to the control board part via a first communication line and receiving target pressure data used for the feedback control program, and a second communication port connected to the control board part via a second communication line and receiving rewrite data of a user setting value included in the feedback control program.

With the objects in view, there is also provided an apparatus control system comprising a pressure control device controlling a pressure of a fluid flowing from an input port to an output port, based on a feedback control program, a control-target apparatus connected to the output port via a fluid piping, a first control apparatus communicably connected to the pressure control device and transmitting target pressure data used for the feedback control program, and a second control apparatus communicably connected to the pressure control device and transmitting rewrite data of a user setting value included in the feedback control program. The pressure control device includes a main body part including an input flow path communicating with the input port, an output flow path communicating with the output port, and a gas exhaust flow path communicating with a gas exhaust port, a gas supply valve attached to the main body part and connected to the input flow path, a gas exhaust valve attached to the main body part and connected to the gas supply valve via a connection flow path, a control board part including a memory storing the feedback control program and controlling the gas supply valve and the gas exhaust valve, a first communication port connected to the control board part via a first communication line and communicably connected to the first control apparatus, and a second communication port connected to the control board part via a second communication line and communicably connected to the second control apparatus.

In accordance with another feature, the first communication port is a port for connecting a first control apparatus transmitting the target pressure data and the second communication port is a port for connecting a second control apparatus transmitting the rewrite data.

In accordance with a further feature, the user setting value is at least any one of a proportional gain of a proportional operation, an integral gain of an integral operation, and a derivative gain of a derivative operation.

In accordance with an added feature, the connection flow path communicates with the output flow path.

In accordance with a concomitant feature, there is provided a main valve provided between the input flow path and the output flow path and controlling a communication state between the input flow path and the output flow path, wherein the connection flow path communicates with a pilot chamber operating the main valve.

Although the systems, apparatuses, and methods are illustrated and described herein as embodied in a pressure control device and an apparatus control system, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a diagram illustrating a pressure control device according to an exemplary embodiment of the preset disclosure;

FIG. 2 is a cross-sectional view illustrating the pressure control device taken along a line II-II illustrated in FIG. 1;

FIG. 3A is a diagram illustrating a portion of a gas supply valve and a gas exhaust value to be enlarged;

FIG. 3B is a diagram illustrating a portion of the gas supply valve and the gas exhaust valve to be enlarged;

FIG. 4 is a diagram illustrating a configuration example of an internal controller;

FIG. 5 is a diagram illustrating an apparatus control system according to an embodiment of the present disclosure;

FIG. 6 is an diagram illustrating the apparatus control system during parameter adjustment;

FIG. 7A is a diagram illustrating a relationship between a proportional gain and pressure measurement data;

FIG. 7B is a diagram illustrating a relationship between a derivative gain and pressure measurement data;

FIG. 7C is a diagram illustrating a relationship between an integral gain and pressure measurement data; and

FIG. 8 is a diagram illustrating an apparatus control system according to another embodiment of the present disclosure.

### DETAILED DESCRIPTION OF THE EMBODIMENTS

Hereinafter, embodiments of the present disclosure will be described in detail with reference to the accompanying drawings. Note that the same or substantially same components or elements are denoted with the same reference characters in the following explanation, and the repetitive description thereof will be omitted.

### First Embodiment

### Pressure Control Device

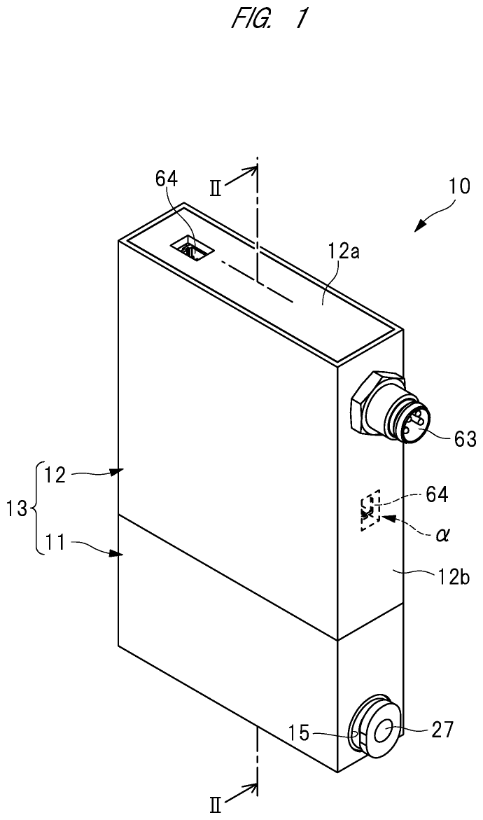

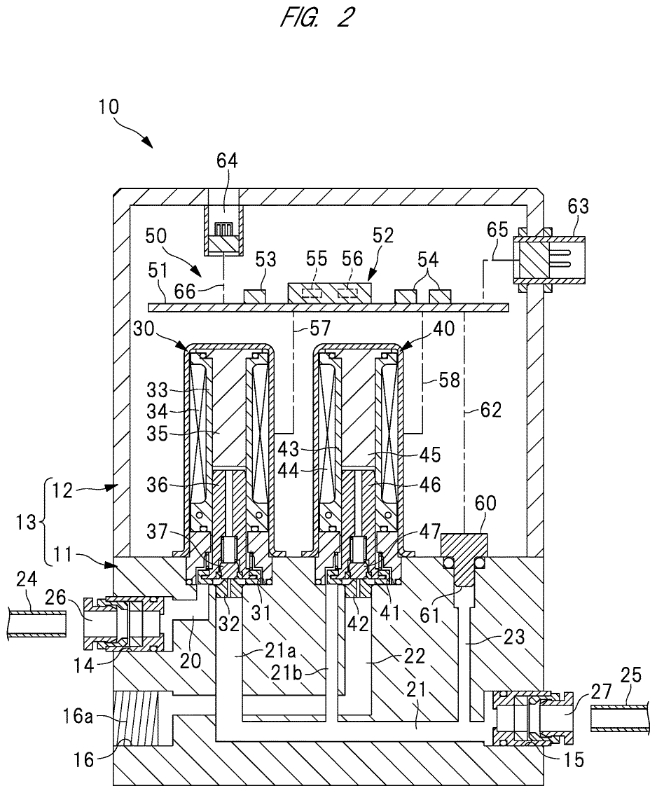

FIG. 1 is a diagram illustrating a pressure control device 10 according to an embodiment of the preset disclosure. FIG. 2 is a cross-sectional view illustrating the pressure control device 10 taken along a line II-II illustrated in FIG. 1. As illustrated in FIGS. 1 and 2, the pressure control device 10 includes a main body part 13 made of a flow path block 11 and a housing 12. As illustrated in FIG., 2, the flow path block 11 is provided with a gas supply port (input port) 14, an output port 15, and a gas exhaust port 16. In addition, the flow path block 11 is also provided with a gas supply flow path (input flow path) 20 communicating with the gas supply port 14, an output flow path 21 communicating with the output port 15, and a gas exhaust flow path 22 communicating with the gas exhaust port 16. The flow path block 11 is further provided with connection flow paths 21a and 21b communicating with the output flow path 21, and a sensor flow path 23 branching from the output flow path 21.

Couplings 26 and 27 for connecting air tubes 24 and 25 are respectively attached to the gas supply port 14 and the output port 15 in the flow path block 11. In addition, the gas exhaust port 16 in the flow path block 11 is provided with a female thread 16a for connecting a muffler 85 described later. Note that the pressure control device 10 is a proportional control valve that controls a pressure of a fluid flowing from the gas supply port 14 to the output port 15, based on a voltage signal or a current signal input from an external controller 82 described later. This pressure control device 10 is also referred to as an electropneumatic regulator.

### Gas Supply Valve and Gas Exhaust Valve

As illustrated in FIG. 2, the pressure control device 10 includes a gas supply valve 30 and a gas exhaust valve 40 attached to the flow path block 11. The gas supply valve 30 is connected to the gas supply flow path 20, and the gas exhaust valve 40 is connected to the gas supply valve 30 via the connection flow paths 21a and 21b. In addition, the connection flow paths 21a and 21b, which connect the gas supply valve 30 and the gas exhaust valve 40, communicate with the output flow path 21.

On an upper surface of the flow path block 11, an attachment concave part 31 for attaching the gas supply valve 30 is formed, and an attachment concave part 41 for attaching the gas exhaust valve 40 is formed. A valve seat 32 attached to an end of the connection flow path 21a extending from the output flow path 21 is arranged in the attachment concave part 31 on the upper surface of the flow path block, and an end of the gas supply flow path 20 opens. In addition, a valve seat 42 attached to an end of the gas exhaust flow path 22 is arranged in the attachment concave part 41 on the upper surface of the flow path block, and an end of the connection flow path 21b extending from the output flow path 21 opens.

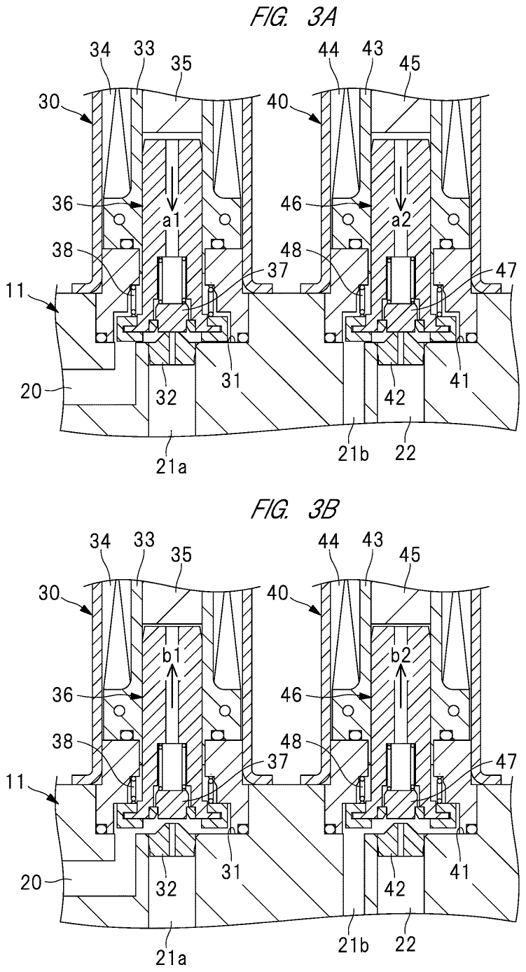

FIGS. 3A and 3B are diagrams each illustrating a portion of the gas supply valve 30 and the gas exhaust valve 40 to be enlarged. As illustrated in FIG. 3A, the gas supply valve 30 includes a coil 34 wrapped around a bobbin 33, a fixed iron core 35 fixed to the inside of the bobbin 33, and a movable iron core 36 movably provided inside the bobbin 33. The movable iron core 36 includes a valve body 37 facing the valve seat 32. In addition, the gas supply valve 30 includes a spring 38 that urges the movable iron core 36 toward the valve seat 32.

As illustrated in FIG. 3A, when the coil 34 in the gas supply valve 30 is de-energized, the movable iron core 36 is pushed by the spring 38 and moves in a direction of an arrow “a1”, and the valve body 37 in the movable iron core 36 is in contact with the valve seat 32 to close the connection flow path 21a, i.e., the output flow path 21. On the other hand, as illustrated in FIG. 3B, when the coil 34 in the gas supply valve 30 is energized, the movable iron core 36 is sucked to the fixed iron core 35 and moves in a direction of an arrow “b1”, and the valve body 37 in the movable iron core 36 separates from the valve seat 32 to open the connection flow path 21a, i.e., the output flow path 21.

Accordingly, the gas supply valve 30 as the open/close valve operates to cause a communication state where the gas supply flow path 20 and the output flow path 21 communicate with each other when the coil is energized, while operating to cause a blocking state where the gas supply flow path 20 and the output flow path 21 are blocked from each other when the coil is de-energized. When the gas supply valve 30 is controlled to cause the communication state, the fluid flows from the gas supply flow path 20 to the output flow path 21, and therefore, the pressure of the fluid discharged from the output flow path 21 can be increased.

In addition, as illustrated in FIG. 3A, the gas exhaust valve 40 includes a coil 44 wrapped around a bobbin 43, a fixed ion core 45 fixed to the inside of the bobbin 43, and a movable iron core 46 movably provided inside the bobbin 43. The movable iron core 46 includes a valve body 47 facing the valve seat 42. In addition, the gas exhaust valve 40 includes a spring 48 that urges the movable iron core 46 toward the valve seat 42.

As illustrated in FIG. 3A, when the coil 44 in the gas exhaust valve 40 is de-energized, the movable iron core 46 is pushed by the spring 48 and moves in a direction of an arrow “a2”, and the valve body 47 in the movable iron core 46 is in contact with the valve seat 42 to close the gas exhaust flow path 22. On the other hand, as illustrated in FIG. 3B, when the coil 44 in the gas exhaust valve 40 is energized, the movable iron core 46 is sucked to the fixed iron core 45 and moves in a direction of an arrow “b2”, and the valve body 47 in the movable iron core 46 separates from the valve seat 42 to open the gas exhaust flow path 22.

Accordingly, the gas exhaust valve 40 as the open/close valve operates to cause a communication state where the gas exhaust flow path 22 and the output flow path 21 communicate with each other when the coil is energized, while operating to cause a blocking state where the gas exhaust flow path 22 and the output flow path 21 are blocked from each other when the coil is de-energized. When the gas exhaust valve 40 is controlled to cause the communication state, the fluid flows from the output flow path 21 to the gas exhaust flow path 22, and therefore, the pressure of the fluid discharged from the output flow path 21 can be decreased.

### Internal Controller

As illustrated in FIG. 2, the pressure control device 10 includes an internal controller (control board part) 50 for controlling the gas supply valve 30 and the gas exhaust valve 40. The internal controller 50 includes a printed circuit board 51 housed in the housing 12, a microcontroller 52 mounted on the printed circuit board 51, an external memory 53 mounted on the printed circuit board 51, and various elements 54 mounted on the printed circuit board 51. Note that a processor 55 and a main memory 56 are embedded into the microcontroller 52. In addition, the internal controller 50 is connected to the coil 34 in the gas supply valve 30 via an energization line 57 as an electric wire, and is connected to the coil 44 in the gas exhaust valve 40 via an energization line 58 as an electric wire.

A pressure sensor 60, which closes the sensor flow path 23, is attached to the upper surface of the flow path block 11. This pressure sensor 60 includes a pressure receiving part 61 that is exposed to the sensor flow path 23. The pressure receiving part 61 in the pressure sensor 60 is made of, for example, a diaphragm including a strain gauge. The pressure sensor 60 is connected to the internal controller 50 via a communication line 62 as an electric wire so that pressure measurement data as a pressure signal can be transmitted from the pressure sensor 60 to the internal controller 50.

In addition, the housing 12 in the pressure control device 10 is provided with a control port (first communication port) 63 and a communication port (second communication port) 64. The control port 63 is connected to the internal controller 50 via a control line (first communication line) 65, and the communication port 64 is connected to the internal controller 50 via a communication line (second communication line) 66. As described later, the control port 63 is a port that receives transmitted data from the external controller 82, and the communication port 64 is a port that receives transmitted data from an adjustment controller 90. Note that the control line 65 can be made of a plurality of electric wires. For example, the control line 65 may be made of a power supply line, an input signal line, and an output signal line, or the control line 65 may be made of a power supply line and a communication line. In addition, the communication line 66 can be made of single or a plurality of electric wires. For example, the communication line 66 may be made of an input signal line, and the communication line 66 may be made of an input signal line and an output signal line. In addition, it goes without saying that a power supply line may be added to the communication line 66 in addition to the signal line.

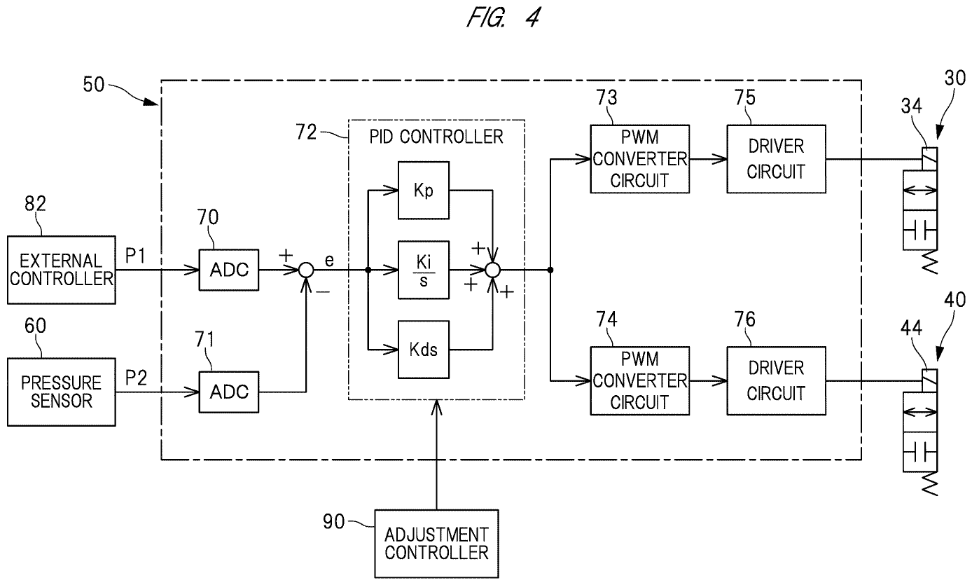

FIG. 4 is a diagram illustrating a configuration example of the internal controller 50. As illustrated in FIG. 4, to the internal controller 50, target pressure data Pl as a control target is input from the external controller 82 described below via an A/D converter 70, and pressure measurement data P2 as a control result is input from the pressure sensor 60 via an A/D converter 71. In addition, the internal controller 50 includes a PID controller 72, PWM converter circuits 73 and 74, and driver circuits 75 and 76 in order to control the gas supply valve 30 and the gas exhaust valve 40 such that the pressure measurement data P2 converges on the target pressure data P1.

The PID controller 72 performs PID control based on a deviation “e” between the pressure data P1 and P2, and outputs a control amount, which has been calculated through the PID control, to the PWM converter circuits 73 and 74. In addition, the PWM converter circuit 73 calculates a pulse signal used for PWM control of the gas supply valve 30, based on the control amount, and outputs this pulse signal to the driver circuit 75. Then, the driver circuit 75 controls the energization state of the gas supply valve 30, based on the pulse signal. Similarly, the PWM converter circuit 74 calculates a pulse signal used for PWM control of the gas exhaust valve 40, based on the control amount, and outputs this pulse signal to the driver circuit 76. Then, the driver circuit 76 controls the energization state of the gas exhaust valve 40, based on the pulse signal.

As described above, the internal controller 50 includes the microcontroller 52 including the processor 55 and the main memory 56. In addition, the main memory (memory) 56 stores the feedback control program for controlling the gas supply valve 30 and the gas exhaust valve 40. When this feedback control program is executed by the processor 55, the PID controller 72 in the microcontroller 52 or the like can be activated. Accordingly, the processor 55 executes the feedback control program by using the target pressure data P1 and the pressure measurement data P2, thereby executing the fluid-pressure feedback control for converging the pressure measurement data P2 to the target pressure data P1.

The feedback control program includes a parameter as the user setting value that can be rewritten by an operator. Accordingly, the feedback control program includes a proportional gain Kp of a proportional operation, an integral gain Ki of an integral operation, and a derivative gain Kd of a derivative operation, as the parameters (user setting values). In a factory shipment stage of the pressure control device 10, note that a predetermined initial value is set as the parameter such as the proportional gain Kp. In addition, in the above description, the main memory 56 in the microcontroller 52 stores the feedback control program. However, the present embodiment is not limited to this description, and the external memory 53 in the internal controller 50 may store the feedback control program.

### Apparatus Control System

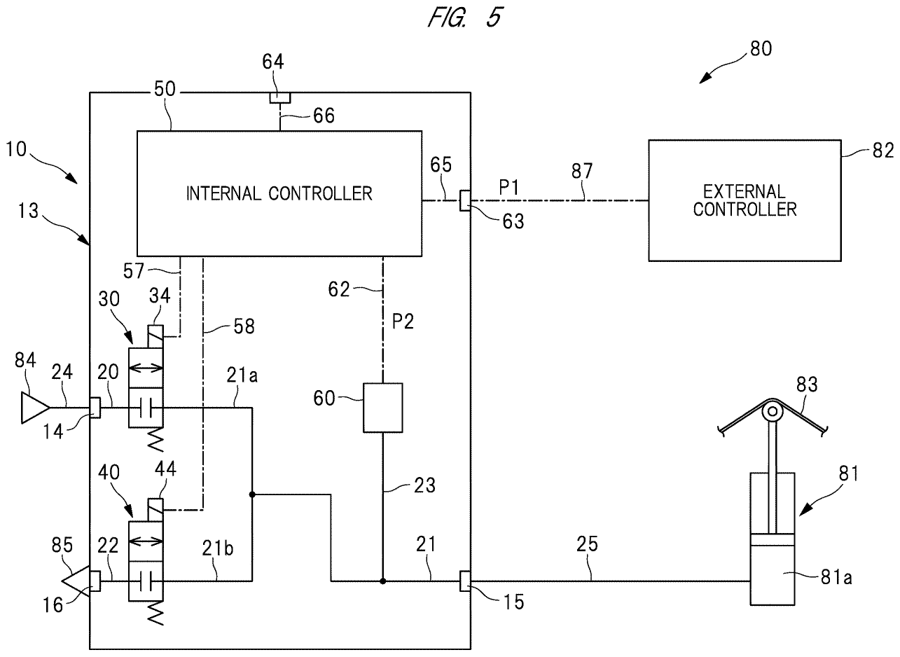

Next, an apparatus control system 80 using the pressure control device 10 will be described. FIG. 5 is a diagram illustrating the apparatus control system 80 according to the embodiment of the present disclosure. As illustrated in FIG. 5, the apparatus control system 80 includes the pressure control device 10, an air cylinder (control-target apparatus) 81, and the external controller 82. The air cylinder 81 controlled by using the pressure control device 10 is a cylinder for adjusting a tension of a sheet material 83 to be wound up. In order to appropriately control the tension of the sheet material 83, it is necessary to accurately control the pressure of air (the fluid) supplied to a pneumatic chamber 81a in the air cylinder. Note that the control-target apparatus is not limited to the air cylinder 81. An air motor, a chemical supply tank, a pilot valve, a process chamber, or the like can also be used as the control-target apparatus.

As illustrated in FIG. 5, a pressure supply source 84 such as an air compressor or an air tank is connected to the gas supply port 14 in the pressure control device 10 via the air tube 24, and a muffler 85 is connected to the gas exhaust port 16 in the pressure control device 10. In addition, the pneumatic chamber 81a in the air cylinder 81 is connected to the output port 15 in the pressure control device 10 via the air tube (fluid piping) 25. Thus, the supply port 14 in the pressure control device 10 is a port for connecting the pressure supply source 84, and the output port 15 in the pressure control device 10 is a port for connecting the pneumatic chamber 81a in the air cylinder 81.

The external controller (first control apparatus) 82 is communicably connected to the control port 63 in the pressure control device 10 via a control line 87 made of a communication cable or the like. For example, a programmable logic controller (PLC) can be used as the external controller 82. Note that the programmable logic controller includes: a microcontroller in which a processor and a memory are embedded although not illustrated; an input circuit to which a signal from each of various sensors and input apparatuses is input although not illustrated; and an output circuit which outputs a signal to the internal controller 50 in the pressure control device 10 although not illustrated. The external controller 82 such as a programmable logic controller includes a function of supplying power to the internal controller 50. In addition, the external controller 82 transmits the target pressure data P1 to the pressure control device 10 in accordance with a predetermined control program in order to appropriately control the tension of the sheet material 83 by using the air cylinder 81. Accordingly, the external controller 82 transmits the target pressure data P1 to be input to the feedback control program.

Thus, after the target pressure data P1 is transmitted from the external controller 82 to the internal controller 50, the internal controller 50 controls the operating states of the gas supply valve 30 and the gas exhaust valve 40 such that the pressure of air supplied to the pneumatic chamber 81a in the air cylinder 81 converges to the target pressure data P1. Accordingly, the internal controller 50 performs the feedback control of the gas supply valve 30 and the gas exhaust valve 40 by using the PID controller 72 such that the pressure measurement data P2 input from the pressure sensor 60 converges to the target pressure data P1 input from the external controller 82.

### Parameter Adjustment

As described above, the internal controller 50 performs the feedback control of the gas supply valve 30 and the gas exhaust valve 40 by using the PID controller 72 such that the pressure measurement data P2 converges to the target pressure data P1. Here, in order to quickly converge the pressure measurement data P2 to the target pressure data P1, it is necessary to adjust the feedback control program in accordance with the configuration of the apparatus control system 80. Accordingly, for the configuration of the apparatus control system 80, it is necessary to adjust the parameter of the feedback control program in accordance with the components such as the air cylinder 81, the air tubes 24 and 25, and the pressure supply source 84. Then, the pressure control device 10 embedded in the apparatus control system 80 includes the communication port 64 for connecting an adjustment controller 90 described later in addition to the control port 63 for connecting the external controller 82.

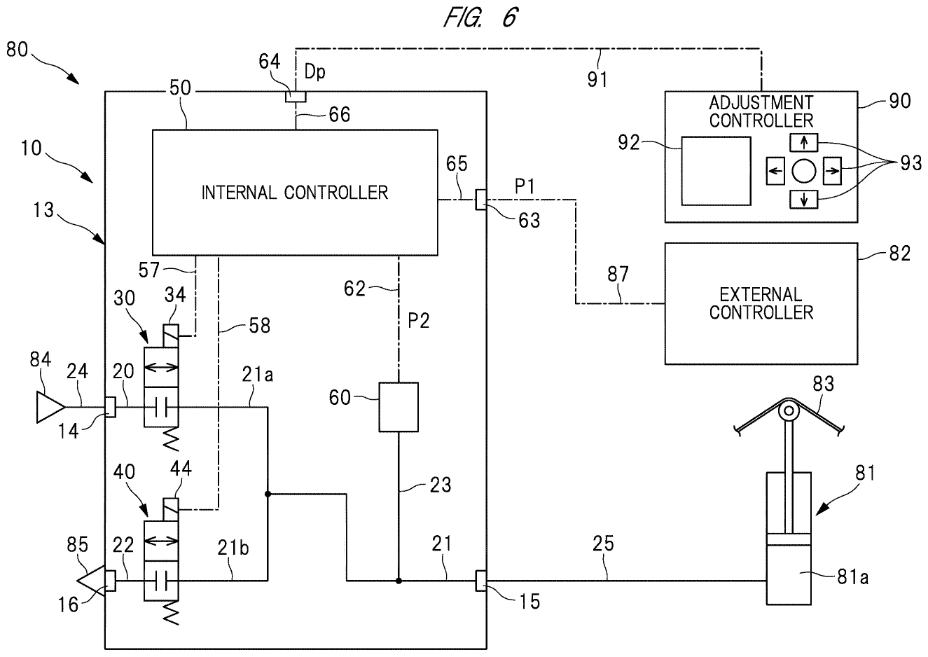

Here, FIG. 6 is a diagram illustrating the apparatus control system 80 during parameter adjustment. As illustrated in FIG. 6, in adjusting the parameter in the feedback control program, the external controller 82 is connected to the control port 63 in the pressure control device 10 while the adjustment controller (second control apparatus) 90 is connected to the communication port 64 in the pressure control device 10. Accordingly, the adjustment controller 90 is communicably connected to the communication port 64 in the pressure control device 10 via a communication line 91.

The adjustment controller 90 includes a display unit 92 for displaying the parameter and an operation unit 93 for selecting the parameter, changing the numerical value and the like. In addition, the adjustment controller 90 includes: a microcontroller in which a processor and a memory are embedded although not illustrated; an input circuit to which a signal from the operation unit 93 is input although not illustrated; and an output circuit which outputs a signal to the internal controller 50 and the display unit 92 although not illustrated. And, in order to rewrite the parameter stored in the main memory 56 in the internal controller 50, the adjustment controller 90 transmits rewrite data Dp of the parameter to the pressure control device 10 in accordance with a predetermined control program. Accordingly, the adjustment controller 90 transmits the rewrite data Dp of the parameter included in the feedback control program.

As illustrated in FIG. 4, the adjustment controller 90 transmits the rewrite data Dp toward the PID controller 72 in the internal controller 50. The rewrite data Dp that can be transmitted from the adjustment controller 90 includes rewrite data of the proportional gain Kp, rewrite data of the integral gain Ki, and rewrite data of the derivative gain Kd. The operator who operates the adjustment controller 90 selects a rewrite-target gain from among the various gains Kp, Ki, and Kd, and increases/decreases and determines the selected gain. As a result, the rewrite data Dp is transmitted from the adjustment controller 90 to the internal controller 50, and the internal controller 50 rewrites the gain in the main memory 56, based on the rewrite data Dp.

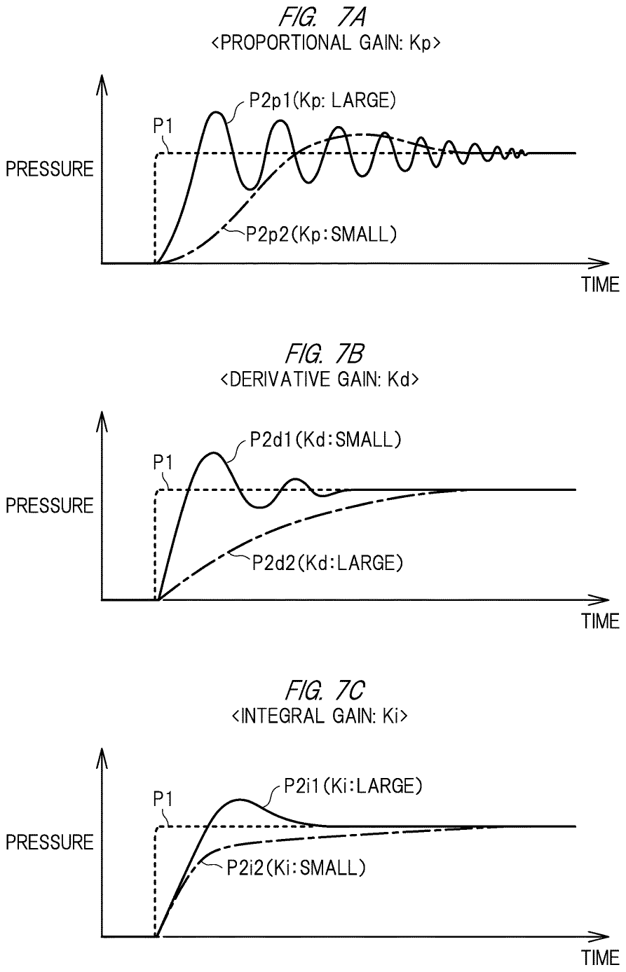

FIG. 7A is a diagram illustrating a relationship between the proportional gain Kp and the pressure measurement data P2, FIG. 7B is a diagram illustrating a relationship between the derivative gain Kd and the pressure measurement data P2, and FIG. 7C is a diagram illustrating a relationship between the integral gain Ki and the pressure measurement data P2. Note that FIGS. 7A to 7C illustrate a situation of the convergence of the pressure measurement data P2 to the target pressure data P1. In addition, in FIGS. 7A to 7C, the pressure measurement data is denoted by each of reference characters P2p1, P2p2, P2d1, P2d2, P2i1, and P2i2 in order to identify a plurality of pieces of the pressure measurement data P2.

As illustrated in FIG. 7A, when the value of the proportional gain Kp is adjusted to be large, the pressure measurement data P2p1 is easy to oscillates but quickly rises. On the other hand, when the value of the proportional gain Kp is adjusted to be small, the pressure measurement data P2p2 slowly rises but is difficult to oscillate.

In addition, as illustrated in FIG. 7B, when a value of the derivative gain Kd is adjusted to be small, the pressure measurement data P2d1 quickly rises but is easy to oscillate. On the other hand, when the value of the derivative gain Kd is adjusted to be large, the pressure measurement data P2d2 slowly rises but is difficult to oscillate.

In addition, as illustrated in FIG. 7C, when a value of the integral gain Ki is adjusted to be large, the pressure measurement data P2i1 is easy to be larger than the target pressure data P1, but the pressure measurement data P2i1 quickly converges to the target pressure data P1. On the other hand, when the value of the integral gain Ki is adjusted to be small, the pressure measurement data P2i2 is difficult to be larger than the target pressure data P1, but the convergence of the pressure measurement data P2i2 significantly gets slower before reaching the target pressure data P1.

The respective values of the proportional gain Kp, the integral gain Ki, and the derivative gain Kd are adjusted as described above, thereby adjusting the property of the PID controller 72, that is, the property of the feedback control program. Accordingly, the parameters of the feedback control program can be adjusted in accordance with the configuration of the apparatus control system 80, and therefore, the pressure measurement data P2 can be quickly converged to the target pressure data P1. Moreover, the pressure control device 10 includes the communication port 64 for connecting the adjustment controller 90 in addition to the control port 63 for connecting the external controller 82. Therefore, an operation unit, a display unit and the like for the parameter adjustment can be eliminated from the pressure control device 10, and the size and the cost of the pressure control device 10 can be avoided from increasing. As described above, in the factory shipment stage of the pressure control device 10, note that the predetermined initial value is set as the parameter such as the proportional gain Kp. Accordingly, depending on the configuration of the apparatus control system 80, it is also assumed that the pressure control device 10 appropriately operates without adjusting the parameter such as the proportional gain Kp.

The value of the proportional gain Kp or the like can be adjusted by the adjustment controller 90 including the operation unit 93 and the like without adjusting the value of the proportional gain Kp or the like by the external controller 82 such as a programmable logic controller. Therefore, the property of the feedback control program can be easily adjusted. In addition, since both the external controller 82 and the adjustment controller 90 are connected to the pressure control device 10, the value of the proportional gain Kp or the like can be adjusted by the adjustment controller 90 while the operation of the pressure control device 10 controlled by the external controller 82 is checked. Therefore, the property of the feedback control program cand be appropriately adjusted. In addition, in a state in which the external controller 82 is not attached to the pressure control device 10, the adjustment controller 90 can be connected to the pressure control device 10, and the value of the proportional gain Kp or the like can be adjusted by the adjustment controller 90. Therefore, even the adjustment operation in a field site where a space is difficult to be ensured can be started by only the connection of the adjustment controller 90 to the pressure control device 10, and the property of the feedback control program can be easily adjusted.

In addition, after the parameter adjustment in accordance with the configuration of the apparatus control system 80, the adjustment controller 90 is detached from the pressure control device 10 as illustrated in FIG. 5. However, the adjustment controller 90 can be attached to the pressure control device 10 as needed. As a result, even when a response delay or a hunting is caused in the pressure measurement data P2 by a temporal change of the apparatus control system 80, the parameter such as the proportional gain Kp can be readjusted, and the air pressure can be appropriately controlled again by the pressure control device 10.

In the above description, the proportional gain Kp, the integral gain Ki, and the derivative gain Kd are rewritten by the adjustment controller 90. However, the present disclosure is not limited to this, and at least any one of the proportional gain Kp, the integral gain Ki, and the derivative gain Kd may be rewritten by the adjustment controller 90. In addition, in the above description, the proportional gain Kp, the integral gain Ki, and the derivative gain Kd are exemplified as the user setting values included in the feedback control program. However, the present disclosure is not limited to this. For example, initial values of various variables as the user setting values, a control period as the user setting value, and the like may be rewritten by the adjustment controller 90.

In addition, the internal controller 50 performs the PID control by using the feedback control program. However, the present disclosure is not limited to this. For example, the internal controller 50 may perform P-control, PI-control, or PD control by using the feedback control program. Note that the rewriting of the proportional gain Kp, the integral gain Ki, and the derivative gain Kd also means rewriting of the proportional gain Kp, an integral time, and a derivative time. Accordingly, the integral gain Ki may be rewritten by rewriting the integral time, and the derivative gain Kd may be rewritten by rewriting the derivative time.

### Second Embodiment

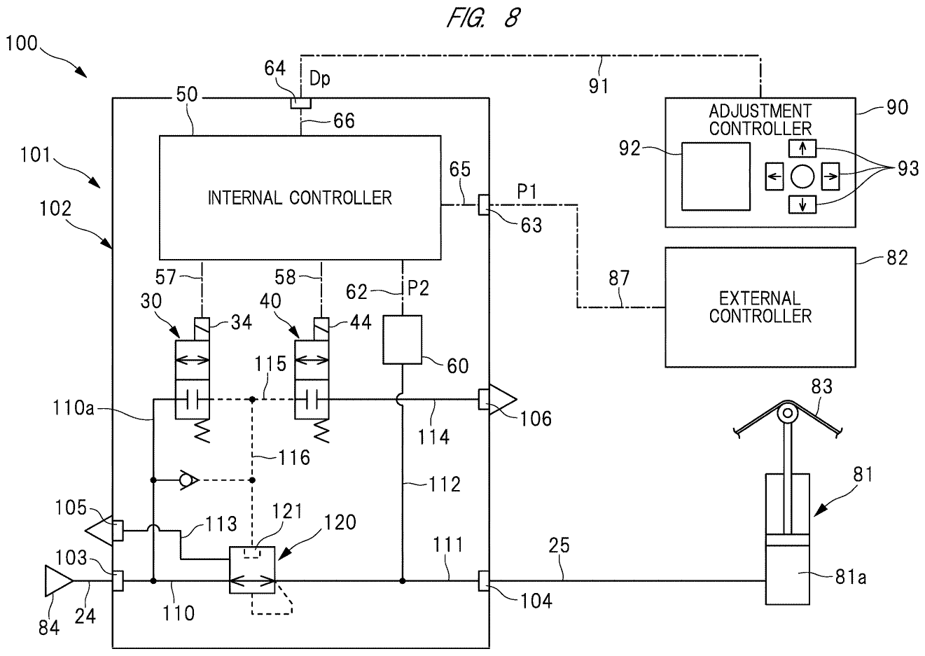

In the pressure control device 10 illustrated in FIGS. 2 and 5, the pressure of the fluid flowing into the output port 15 is directly controlled by the gas supply valve 30 and the gas exhaust valve 40. However, the present disclosure is not limited to this, and the pressure of the fluid flowing into the output port 15 may be indirectly controlled by the gas supply valve 30 and the gas exhaust valve 40. Accordingly, the present disclosure is not limited to the direct-acting-type pressure control device 10, and the technique of the present disclosure may be applied to a pilot-type pressure control device. Here, FIG. 8 is a diagram illustrating an apparatus control system 100 according to another embodiment of the present disclosure. In FIG. 8, note that similar members and parts to the members and the parts illustrated in FIG. 5 are respectively denoted by the same reference characters, and the descriptions thereof is omitted.

As illustrated in FIG. 8, the apparatus control system 100 includes a pressure control device 101, the air cylinder 81, the external controller 82, and the adjustment controller 90. A main body part 102 in the pressure control device 101 includes a gas supply port (input port) 103, an output port 104, a gas exhaust port 105, and a gas exhaust port 106. The main body part 102 is provided with a gas supply flow path (input flow path) 110 communicating with the gas supply port 103 and a branch flow path (input flow path) 110a branching from the gas supply flow path 110. In addition, the main body part 102 is provided with an output flow path 111 communicating with the output port 104 and a sensor flow path 112 branching from the output flow path 111. Further, the main body part 102 is provided with a gas exhaust flow path 113 communicating with the gas exhaust port 105 and a gas exhaust flow path 114 communicating with the gas exhaust port 106.

The pressure control device 101 includes a main valve 120 arranged between the gas supply flow path 110 and the output flow path 111 in order to control a communication state among the gas supply flow path 110, the output flow path 111, and the gas exhaust flow path 113. This main valve 120 includes: a diaphragm that controls the communication state among the gas supply flow path 110, the output flow path 111, and the gas exhaust flow path 113 although not illustrated; and a pilot chamber 121 that is defined on one side of this diaphragm. Note that the gas supply flow path 110 and the output flow path 111 can communicate with each other via the main valve 120 by increasing the pressure of air supplied to the pilot chamber 121. On the other hand, the output flow path 111 and the gas exhaust flow path 113 can communicate with each other via the main valve 120 by decreasing the pressure of air supplied to the pilot chamber 121.

In order to control this main valve 120, the pressure control device 101 includes the gas supply valve 30 and the gas exhaust valve 40. The gas supply valve 30 is arranged between the branch flow path 110a and a connection flow path 115, and the gas exhaust valve 40 is arranged between the connection flow path 115 and the gas exhaust flow path 114. Accordingly, the gas supply valve 30 is connected to the gas supply flow path 110 via the branch flow path 110a, the gas exhaust valve 40 is connected to the gas supply valve 30 via the connection flow path 115, and the gas exhaust flow path 114 is connected to the gas exhaust valve 40. In addition, a pilot flow path 116 extending from the pilot chamber 121 is connected to the connection flow path 115 that connects the gas supply valve 30 and the gas exhaust valve 40. Accordingly, the connection flow path 115, which connects the gas supply valve 30 and the gas exhaust valve 40, communicates with the pilot chamber 121 that operates the main valve 120.

The gas supply valve 30 is controlled to cause the communication state, thereby making flow of the fluid flowing from the branch flow path 110a to the connection flow path 115, and therefore, the pressure of the fluid supplied from the pilot flow path 116 to the pilot chamber 121 can be increased. On the other hand, the gas exhaust valve 40 is controlled to cause the communication state, thereby making flow of the fluid flowing from the connection flow path 115 to the gas exhaust flow path 114, and therefore, the pressure of the fluid supplied from the pilot flow path 116 to the pilot chamber 121 can be decreased. Accordingly, the main valve 120 can be indirectly controlled through the pilot fluid in the pilot chamber 121 by controlling the gas supply valve 30 and the gas exhaust valve 40.

Even this pilot-type pressure control device 101 includes the communication port 64 for connecting the adjustment controller 90 in addition to the control port 63 for connecting the external controller 82. As a result, the user setting value such as the proportional gain Kp can be adjusted in accordance with the configuration of the apparatus control system 100 as similar to the above-described direct-acting-type pressure control device 10, and therefore, the pressure measurement data P2 can be quickly converged to the target pressure data P1. Accordingly, the pressure control device 101 can be appropriately controlled in accordance with the configuration of the apparatus control system 100.

### Another Embodiment

It is needless to say that the present disclosure is not limited to the foregoing embodiments, and various modifications can be made within the scope of the present disclosure. For example, in the example illustrated in FIGS. 1 and 2, the communication port 64 is provided on the upper surface 12a of the housing 12. However, a placement position of the communication port 64 is not limited to the upper surface 12a. For example, the communication port 64 for connecting the adjustment controller 90 may be provided on a side surface 12b of the housing 12, as illustrated with an arrow “a” in FIG. 1.

In the above description, the internal controller 50 is made of the microcontroller 52. However, the present disclosure is not limited to this, and the internal controller 50 may be made of an analog circuit made of an element such as an operational amplifier. In the above description, the power is supplied from the external controller 82 to the internal controller 50. However, the present disclosure is not limited to this. For example, the housing 12 is provided with a power supply port, thereby directly connecting the power to the pressure control device 10.

In the above description, the gas supply valve 30 and the gas exhaust valve 40 are PWM-controlled, thereby controlling the fluid pressure in each of the output flow paths 21 and 111. However, the present disclosure is not limited to this. For example, each of the gas supply valve 30 and the gas exhaust valve 40 may be made of a proportional control valve. When the valve as the proportional control valve controls the energization current value and the energization voltage value of the coil, a flow-rate proportional control valve that can adjust the opening of the valve body can be used. In addition, a piezoelectric-type flow-rate proportional control valve that can adjust the opening of the valve body by using a piezoelectric element can be used as the proportional control valve.

In the example illustrated in FIG. 2, the air tubes 24 and 25 are respectively connected to the gas supply valve 14 and the output port 15. However, the present disclosure is not limited to this, and steel pipes may be respectively connected to the gas supply port 14 and the output port 15. In addition, in the above description, the muffler 85 is attached to the gas exhaust port 16. However, the present disclosure is not limited to this, and an air tube or a steel pipe may be connected to the gas exhaust port 16. In addition, in the examples illustrated in FIGS. 2, 6, and 8, the pressure sensors 60 respectively provided in the pressure control devices 10 and 101 are used. However, the present disclosure is not limited to this, and a pressure sensor separate from the pressure control devices 10 and 101 may be used. In the above description, note that the pressure of the fluid, i.e., air as gas is controlled by each of the pressure control devices 10 and 101. However, the present disclosure is not limited to this, and a pressure of a fluid other than air may be controlled by each of the pressure control devices 10 and 101.

### EXPLANATION OF REFERENCE CHARACTERS

10 . . . pressure control device
13 . . . main body part
14 . . . gas supply port (input port)
15 . . . output port
20 . . . gas supply flow path (input flow path)
21 . . . output flow path
21a, 21b . . . connection flow path
25 . . . air tube (fluid piping)
30 . . . gas supply valve
40 . . . gas exhaust valve
50 . . . internal controller (control board part)
56 . . . main memory (memory)
63 . . . control port (first communication port)
64 . . . communication port (second communication port)
65 . . . control line (first communication line)
66 . . . communication line (second communication line)
80 . . . apparatus control system
81 . . . air cylinder (control-target apparatus)
82 . . . external controller (first control apparatus)
90 . . . adjustment controller (second control apparatus)
100 . . . apparatus control system
101 . . . pressure control device
102 . . . main body part
103 . . . gas supply port (input port)
104 . . . output port
110 . . . gas supply flow path (input flow path)
110a . . . branch flow path (input flow path)
111 . . . output flow path
115 . . . connection flow path
120 . . . main valve
121 . . . pilot chamber
P1 . . . target pressure data
Dp . . . rewrite data
Kp . . . proportional gain (user setting value)
Ki . . . integral gain (user setting value)
Kd . . . derivative gain (user setting value)

What is claimed is:

1. A pressure control device controlling a pressure of a fluid flowing from an input port to an output port, comprising:
a main body part including an input flow path communicating with the input port, an output flow path communicating with the output port, and a gas exhaust flow path communicating with a gas exhaust port;
a gas supply valve attached to the main body part and connected to the input flow path;
a gas exhaust valve attached to the main body part and connected to the gas supply valve via a connection flow path;
a control board part including a memory storing a feedback control program and controlling the gas supply valve and the gas exhaust valve;
a first communication port connected to the control board part via a first communication line and receiving target pressure data used for the feedback control program; and
a second communication port connected to the control board part via a second communication line and receiving rewrite data of a user setting value included in the feedback control program.

2. The pressure control device according to claim 1, wherein:
the first communication port is a port for connecting a first control apparatus transmitting the target pressure data; and
the second communication port is a port for connecting a second control apparatus transmitting the rewrite data.

3. The pressure control device according to claim 1, wherein the user setting value is at least any one of a proportional gain of a proportional operation, an integral gain of an integral operation, and a derivative gain of a derivative operation.

4. The pressure control device according to claim 1, wherein the connection flow path communicates with the output flow path.

5. The pressure control device according to claim 1, further comprising a main valve provided between the input flow path and the output flow path and controlling a communication state between the input flow path and the output flow path, wherein the connection flow path communicates with a pilot chamber operating the main valve.

6. An apparatus control system, comprising:
a pressure control device controlling a pressure of a fluid flowing from an input port to an output port, based on a feedback control program;
a control-target apparatus connected to the output port via a fluid piping;
a first control apparatus communicably connected to the pressure control device and transmitting target pressure data used for the feedback control program; and
a second control apparatus communicably connected to the pressure control device and transmitting rewrite data of a user setting value included in the feedback control program,
wherein the pressure control device includes:
a main body part including an input flow path communicating with the input port, an output flow path communicating with the output port, and a gas exhaust flow path communicating with a gas exhaust port;
a gas supply valve attached to the main body part and connected to the input flow path;
a gas exhaust valve attached to the main body part and connected to the gas supply valve via a connection flow path;
a control board part including a memory storing the feedback control program and controlling the gas supply valve and the gas exhaust valve;
a first communication port connected to the control board part via a first communication line and communicably connected to the first control apparatus; and
a second communication port connected to the control board part via a second communication line and communicably connected to the second control apparatus.

7. The pressure control device according to claim 6, wherein:
the first communication port is a port for connecting a first control apparatus transmitting the target pressure data; and
the second communication port is a port for connecting a second control apparatus transmitting the rewrite data.

8. The pressure control device according to claim 6, wherein the user setting value is at least any one of a proportional gain of a proportional operation, an integral gain of an integral operation, and a derivative gain of a derivative operation.

9. The pressure control device according to claim 6, wherein the connection flow path communicates with the output flow path.

10. The pressure control device according to claim 6, further comprising a main valve provided between the input flow path and the output flow path and controlling a communication state between the input flow path and the output flow path, wherein the connection flow path communicates with a pilot chamber operating the main valve.
